(19) United States
(12) Patent Application Publication
(10) Pub. No.: US 2018/0279594 A1
(43) Pub. Date: Oct. 4, 2018

(54) AQUATIC DEVICE WITH HANDHELD PIECE AND DRONE

(71) Applicant: Eric J. Raskas, Saint Louis, MO (US)

(72) Inventor: Eric J. Raskas, Saint Louis, MO (US)

(21) Appl. No.: 15/393,004

(22) Filed: Mar. 28, 2017

(51) Int. Cl. A01K 91/02; A01K 97/12; B63B 35/14; B63H 1/14; A01K 81/00; A01K 87/00; A01K 83/00; B63H 25/42; G05D 1/00; H04N 7/18

(52) U.S. Cl. CPC A01K 91/02; A01K 97/125; B63B 35/14; B63H 1/14; A01K 81/00; B63B 2035/008; A01K 83/00; B63H 25/42; G05D 1/0016; G05D 1/0038; H04N 7/185; A01K 87/00

(57) ABSTRACT

The present invention describes a drone that is launched from a handheld piece and may be navigated by controls that are positioned on the handheld piece in any direction at varying speeds. After the drone is launched the operator of the handheld piece deploys a hook stowed in the drone that descends into the water. Although the present invention is most suitable for fishing it will be readily apparent that there are several other important fields of use where this invention may be beneficial by substituting the hook with other components.

### REFERENCE TO RELATED APPLICATIONS

The present application relates and claims priority to U.S. provisional patent application No. 62/387,567 filed on Dec. 28, 2015, the entire contents of which are incorporated herein by reference.

### BACKGROUND OF THE INVENTION

### Field of the Invention

This invention relates primarily to the field of the sport of fishing but has additional fields of applications as will be described herein.

### Description of Related Art

The sport and livelihood of fishing has evolved from its earliest forms as means of trapping aquatic life by the use of nets that are placed in certain proximities where fish are known to swim or cages which have generally the same objective to the use of elongated rods that have a string or line attached one end to the rod and at the opposite end they are tethered ultimately to a hook carrying bait whereby the fish becomes caught on the hook after trying to take the bait.

With the exception of adding mechanisms to reel in the fish by the use of spinner reels and other types of reels and different types of lures for the fish, the basic underlying mechanics have mostly gone unchanged for at least millennia.

One of the main drawbacks concerning the method just described is the lack of any ability to navigate the line once it is in the water. With the exception of being able to control the back reel of the line to try and attract a fish, there is no other means of moving the line once it has become in contact with the water.

As examples, in the US patent patents U.S. Pat. No. 5,363,587A (44), U.S. Pat. No. 6,520,105B2 (16), U.S. Pat. No. 5,165,193A (37), U.S. Pat. No. 4,856,222A (21), U.S. Pat. No. 6,760,995B2, U.S. Pat. No. 4,856,222, and U.S. Pat. No. 4,757,633A, a remote-controlled and motorized boat delivers the fishing hook and bait to a selected location. These fishing devices represent a departure from the traditional bait delivery systems using a fishing rod. These systems do not provide visual cue of a fishing bobber to indicate a fish has struck the hook. They also lack the capabilities of casting the fishing line with the bait, or reeling in and out the bait as done in conventional fishing. In addition to the possible lack of reliable and timely retrieval of the caught fish, these systems do not offer the entertaining experience of traditional fishing with a fishing rod.

Various remotely controlled fishing bobbers have been developed. For example, U.S. Pat. No. 5,086,581, US 20050102883, and U.S. Pat. No. 8,627,593. These devices feature fishing bobbers with various size, structure and electronics. The performance of these devices may be limited by the inadequacy of user control and lack of moving flexibility. There is continuous need for fishing devices that provide efficient fishing capability as well as interactive and entertaining fishing experiences.

### SUMMARY OF THE INVENTION

The present invention concerns a new and improved fishing rod with an aquatic drone that has the ability to navigate the fishing line once it is in the water. The fishing rod and drone can be controlled by a interactive user interface.

As will become apparent throughout the ongoing description, the present invention provides a fundamental shift in how the fishing line is delivered into the water and how the fishing line is controlled once it is in the water. With the present invention, fishing becomes a much more interactive process between the disposition and location of the line and the person conducting the fishing.

As will further be apparent, the present invention also may be used for surface water and underwater activities beside fishing, including underwater exploration, sensing, sample retrieval and placement, and a means to emit certain types of energy directly into the environment.

In one embodiment of the present invention, the primary agent for conducting the fishing is a small aquatic drone that is tethered to a conventional reeling mechanism contained within or on a handheld piece which is also used as a means for controlling the movement of the vessel. Here, aquatic drone is a remotely guided and controlled robotic vessel used in an aqueous or other liquid environment. The handheld piece further serves as a means for launching the vessel into the water. Once in the water the controls on the handheld piece are used to further guide the vessel to the area desired and at any time after the vessel lands in the water, a small compartment that is at the lower half of the vessel facing the water is opened to allow for the deployment of a section of line with a hook attached. After the fish or aquatic creature has bit the hook the operator may use a conventional reeling mechanism to reel the fish or creature along with the attached vessel back to the location of the operator and obtain the fish in a conventional manner. After releasing the fish from the hook the hook may again be set back into the compartment and the compartment closed. The entire process may then be repeated. If necessary, the small segment of line may also be replaced and may be adjusted to any particular length desired by the operator. In such a capacity, the vessel also serves the function of a bobber as well. A certain portion of the vessel is maintained above water by having the top section of the vessel being made of a material capable of flotation such as foam or the outer shell of the vessel may be filled with a floatable form of hard foam or similar material to prevent the robotic vessel from sinking. Further looking at the internal contents of the robotic vessel, the vessel has a propulsion means and a navigation means. There are numerous mechanisms for accomplishing this that are well known to the those skilled in the art. One embodiment of the present invention utilizes a simplified form of two motor assemblies directly facing each other with a small gap in between to allow for the movement and flow of water. The motors are controlled independently and remotely by the operator via a wired or wireless signal that is passed between the handset and the robotic vessel. In one instance both motors are propelled forward thereby causing the vessel to be propelled forward. In another instance both motors are reversed and the movement of the robotic vessel will also be in reverse. By independently altering the speed of each motor, the robotic vessel may be turned either to the left or to the right at any degree and rate according to the balance of control of the two motors. Each of these functions may be controlled by the operator remotely using the holding portion of the handheld piece that also includes the function of a joystick(s) or similar type mechanism such as buttons or switches to control the motors. It would also be possible to use a visual display that responds to touch without the use of physical controls.

As mentioned previously, although the primary function of this device is well suited for fishing, the device has other applications that are contemplated in the fields of sensory applications and location and detection equipment. By incorporating a sensor to the device such as visual sensor in the form of a camera, CCD, CMOS in either visible or non-visible wavelengths, the device may be used to detect, view, and/or record certain underwater phenomena. Alternatively, by adapting sonar to the vessel the device may be used locate an object underwater. By incorporating a microphone the vessel may be used to collect sounds emitted under water and by including speakers the device may be used to broadcast sounds under water. By replacing the hook with a robotically attached positioning arm and grasping mechanism the device may be used to cultivate certain inanimate bodies or living organisms residing under water. Additionally, by incorporating on the grasping element a chemical sensor, the operator will be able to detect biological, organic, or inorganic compounds based upon the method used to detect the analyte.

It's apparent from the above description in all cases whether it is used in the field of fishing or any other field described, there are certain electronic components that are incorporated into the drone that will be, at least, partially submerged in either an aqueous environment or other liquid environment. This requires that the electronic components be protected from the moisture and other chemicals in the environment which they will be exposed to in order to preserve their proper electric function. In the case of an aqueous environment, there are already well established coating, encapsulating, and potting means guarding the electronics against exposure to moisture and keeping them waterproof even while fully submerged. This applies to freshwater as well as saltwater environment where corrosion issues become more of a concern. It is also understood that other liquid environments may require their own special means for protecting the electronics whether they are exposed to certain organic solvents, or environments with extreme acidic or basic pH conditions.

Now focusing on the handheld piece which remains always available to the operator to launch the aquatic drone and control it while it is in the liquid environment. The handheld piece or hand receptacle includes a means for grasping the hand unit, a means for launching the aquatic drone into the liquid environment, a means for controlling or navigating the aquatic drone in the liquid, and a means for retrieving the aquatic drone back into the possession of the operator. The grasping means may be any suitable material that is ergonomic and not sensitive to moisture. The launching means may be any suitable actuator mechanism that is capable of a force necessary to propel the robotic vessel into the liquid safely away from the operator and whereby the operator may use the control functions on the device to thereafter navigate the vessel to a new position by visual reference or using an underwater video camera system in an application which requires the vessel to be completely submerged while the display remains visible to the operator through a separate screen that receives a signal from the underwater video camera. The actuating means to launch the robotic vessel may be of mechanical, electronic, or pneumatic. One embodiment of the present invention discloses a ball in cup mechanism whereby when the handheld piece attached to the cup is cast forward, the aquatic drone is released from the cup and propelled forward by manual force some distance to the water while carrying the line with it. In this manner the aquatic drone can be safely delivered into the water or other liquid. Once landing safely on the surface of the water, the operator of the device may use controls for navigating the robotic vessel wirelessly or via a wired connection which establish electrical contact and/or digital communication between the portion held in the hand of the operator and the aquatic drone that has been deployed. Using these controls the operator may navigate the aquatic drone in any direction to any point or destination selected by the operator so long as the total distance does not exceed the length of the line that attaches the aquatic drone to the hand-held portion. Once the operator has determined a satisfactory location, the operator may release grasping mechanism that is stowed in a compartment which may be opened and closed using a control on the hand-held portion. This compartment may be controlled by a solenoid actuator, a stepper motor, or a material that changes its physical shape in response to heat generated from an electric current. There are numerous such mechanisms that are known to those skilled in the art of mechatronics. The hook is stowed in the compartment using a separate actuating means. Another possible launching mechanism may be the use of compression spring with a retainer platform for the vessel. When the compression spring is retracted it locks into place until it is released by a triggering mechanism using a torsion spring. The force of the recoil of the compression spring is transferred to the aquatic drone which is then propelled in the air a distance of and lands in the water. Other means for launching the aquatic drone into the water include solenoids, motors with rotating arms, compression of gas, an electrical rail system and numerous other manual contraptions that could be designed to accomplish the same objective.

The control unit is a separate electronic assembly that is incorporated directly into the handheld piece and accessible to the operator via a user interface. In one embodiment, the control panel will include both the individual controls for navigating the vessel and releasing the hook at the appropriate time. Additionally, the control panel may have other switches including those used to control illumination of the robotic vessel and enabling or disabling audible alerts. The control panel may also include means for controlling other features where the device is used in applications other than fishing. In one embodiment, the device may have a display which carries the signal transmitted from a video camera attached to the robotic vessel. In another embodiment, there is user control to operate the robotic arm and grasping hand to retrieve samples or to analyze samples using the on-board sensor systems. Each of these features and their respective controls would be incorporated into the handheld piece. Alternative the entire handheld piece may be linked wirelessly to a remote application that is used to control any one of the above described features while not directly having a grasp on the handheld piece or while holding the handheld piece in one hand and using the control in another hand. It is yet another possibility that the features of the robotic vessel may be controlled from a completely remote location while the handheld piece remains secured and attached to the line and the robotic vessel. In some instances it may be advantageous to have a larger view of what the robotic vessel is seeing or the functions that it is performing. In such cases it is contemplated that the video signal and other computer control functions may be wirelessly transmitted or transmitted by cable to secondary device or network that is operating software that may perform duplicitous functions of the control panel on the handheld device or may have more elaborate analytical functions that can be used where they are required for the application. The handheld piece will also require means for powering the internal electronics within the handheld piece and in the present instance uses a rechargeable cell or battery of cells such as a lithium ion or lithium polymer cell. The remote vessel also has mechanisms that require power and may either obtain that power by a direct cable to the handheld piece whereby the cable assembly or fishing line is made up partly of conducting component wires.

In one embodiment of the present invention, the aquatic drone includes a rechargeable cell and may be charged separately or by attaching it via a cable or snap-fit mechanism directly to the handheld piece assembly or possibly by contacts that reside the cup portion that are designed to maintain electrical contact whenever the robotic vessel is stowed in the retaining and launching cup.

### BRIEF DESCRIPTION OF THE DRAWINGS

Embodiments of the present invention will now be described, by way of example only, with reference to the following drawings, in which:

FIG. 1 is a block diagram illustrating the main components of an embodiment of the handheld piece.

FIG. 2 is a block diagram illustrating the main components of an embodiment of the aquatic drone.

FIG. 3 is a left side perspective view of an embodiment of the handheld piece.

FIG. 4 is a right side perspective view of an embodiment of the handheld piece.

FIG. 5 is a perspective view of the handheld piece in FIG. 3 with an embodiment of the aquatic drone.

FIG. 6 is a perspective view of the handheld piece in FIG. 3 after manually launched the aquatic drone.

FIG. 7 is an exploded view of the handheld piece in FIG. 3 to show all the major features and the internal and external components.

FIG. 8 is a left perspective view of the upper part of the handheld piece in FIG. 3 without the aquatic drone.

FIG. 9 is a front view of an embodiment of the aquatic drone.

FIG. 10 is a perspective view of the aquatic drone in FIG. 10.

FIG. 11 is an exploded view of the aquatic drone in FIG. 10 to show all the internal and external components.

FIG. 12 shows an embodiment of the control board and LCD touch display.

FIG. 13 shows an embodiment of the aquatic drone with a robotic grasping arm deployed.

### REFERENCE NUMERALS IN THE DRAWINGS

For a more complete understanding of the present invention parts, reference is now made to the following descriptions:
010—Handheld piece control unit.
011—Handheld piece power source.
012—Handheld piece communication unit.
013—Input devices.
014—Output device.
020—Aquatic drone control unit.
021—Aquatic drone power source.
022—Aquatic drone communication unit.
023—Sensing Devices.
024—Aquatic drone signal light.
025—Fishing hook deployment control.
026—Motors and propellers.
100—The handheld piece.
101—Handheld piece handle upper section.
102—Handheld piece handle lower section.
103—Lower section of case.
104—Reel.
105—Reel crank.
106—Lateral support for reel release trigger.
107—Reel release trigger.
108—LCD touch display.
109—Mounting frame LCD display top.
110—Mounting frame LCD display bottom.
111—Mounting frame LCD display back.
112—Joy stick.
113—Upper section of case.
114—Decorative front panel.
115—Split section of handheld piece.
116—Middle split section of rod.
117—Split section for launching pod.
118—The holding chamber of the drone
119—Handheld piece fishing line.
120—A series of stabilization rings.
121—The upper part of the handheld piece.
200—The drone.
201—Translucent dome.
202—Printed circuit board.
203—Drone external shell top half.
204—Battery.
205—Drone motor for line release and uptake.
206—Magnetic coupling and rotating of the drone motor for line release and uptake.
207—First drone propulsion motor.
208—Magnetic coupling and rotating of the first drone propulsion motor.
209—Magnetic coupler of propeller to first drone propulsion motor.
210—Propeller of the first drone propulsion motor.
211—Second drone propulsion motor.
212—Magnetic coupler and rotating of the second drone propulsion motor.
213—Magnetic coupler of propeller to the second drone propulsion motor.
214—Propeller of the second drone propulsion motor.
215—Spindle for line release.
216—Pressure roller for securing line to spindle.
217—Polymer support and mounting frame for spindle.
218—Drone bay control level.
219—The inside part of the drone bay control level.
220—Right bay access door to hock and bay.
221—Left bay access door to hock and bait.
222—Chassis for the drone.
223—Drone external shell bottom half.
224—Secondary light on the bottom of the drone.
225—Hatch.
226—Hook.
227—Drone fishing line.
228—Drone LED.
300—The control board and LCD touch display.
301—Main battery indicator.
302—Battery indicator for the drone.
303—Main controller transmitter signal to drone.
304—Illumination on/off switch for drone beacon.
305—Control to release hook and bait from the bottom bay of the drone.
306—Rainbow directional controller for the drone.
307—Slider indicator for controlling the power of the motors and the speed of movement of the drone.
308—Sinker line gauge.
309—The fish icon.
401—Robotic arm.
402—Grabbing mechanism.

### DETAILED DESCRIPTION OF THE INVENTION

The following detailed description includes preferred embodiments of the invention. The description is not to be taken in a limiting sense, but is made merely for the purpose of illustrating the general principles of the invention.

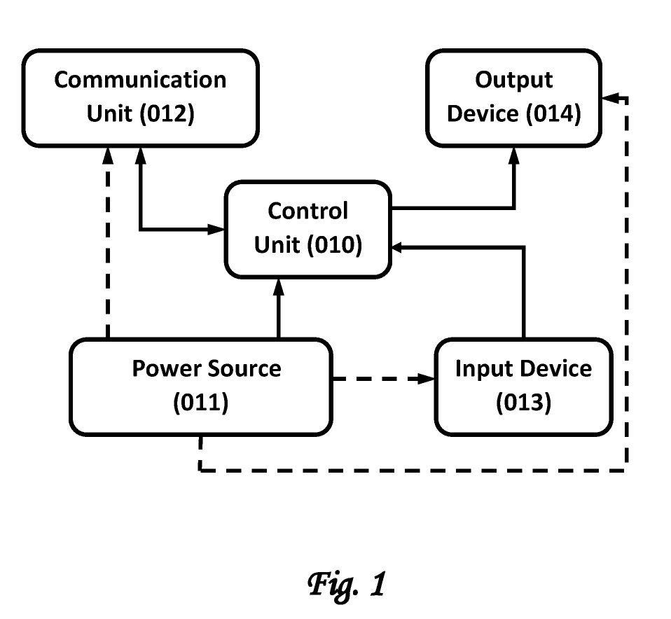

The fishing device in the present invention comprises a handheld piece and a remotely controlled aquatic drone. FIG. 1 is a block diagram depicting the electronic components of an embodiment of the handheld piece. The handheld piece comprises a power source (011), a control unit (010), a communication unit (012), one or more input devices (013), and an output device (014). In one embodiment, the power source (011) is a portable rechargeable battery, such as a lithium ion or lithium polymer cell. The control unit (010) is a separate electronic assembly that is incorporated directly into the handheld piece and accessible to the operator through one or more input devices (013). Embodiments of input devices include switches, buttons, dials, keyboards, joysticks, touch screens, and other type of input devices. The control unit (010) is also connected to the communication unit (012), which is in communication with the aquatic drone through wired or wireless signals. The output device (014) may comprises LCD displays, LED indicators, or other visual or audio output devices to provide system status and information to the user.

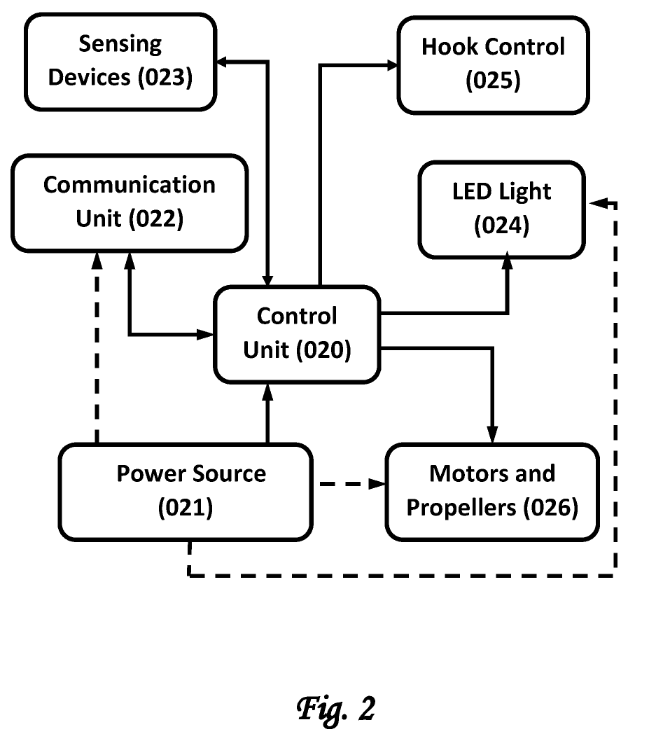

FIG. 2 is a block diagram depicting the electronic components of an embodiment of the aquatic drone. The aquatic drone comprises a drone power source (021), a drone control unit (020), a drone communication unit (022), and components for moving and steering, such as motors and propellers (026). The aquatic drone may also comprise a fishing hook storing and deploying mechanism (025) and sensing devices (023), such as CCD cameras and SONARs. The drone communication (022) is connected with the handheld piece communication unit (012) via wireless or wired signal transmission. It may receive commands from the handheld piece and transmit the status and sensing data of the aquatic drone. The aquatic drone may also comprise an LED light to signal the position of the aquatic drone.

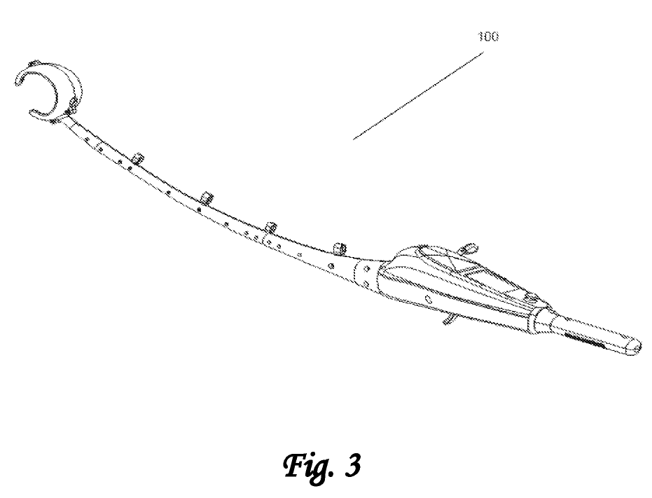

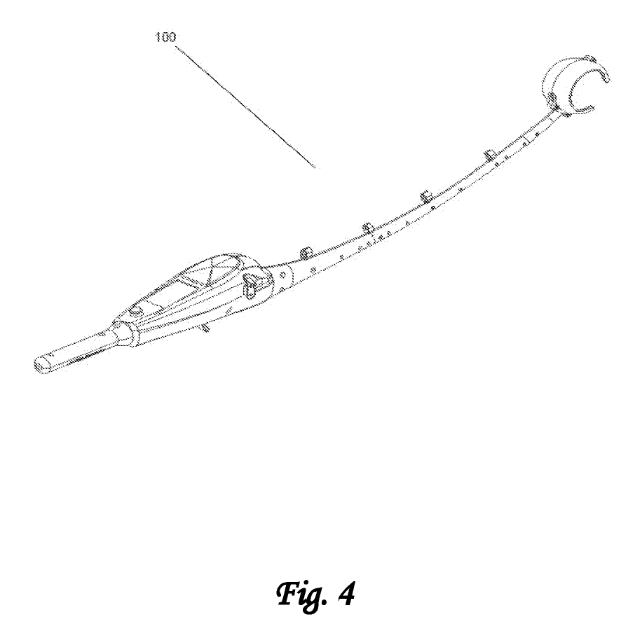

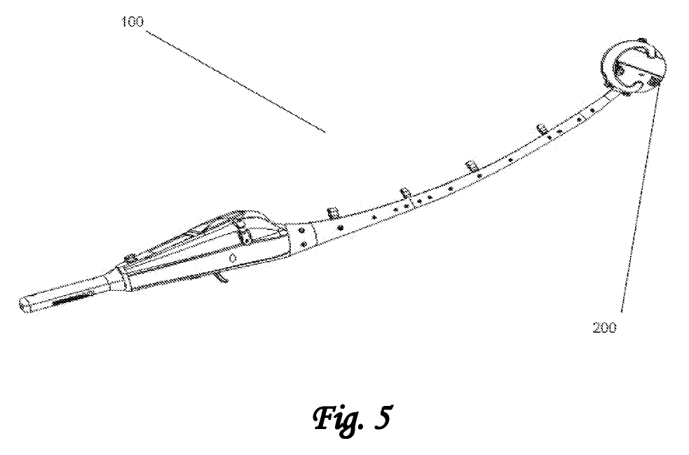

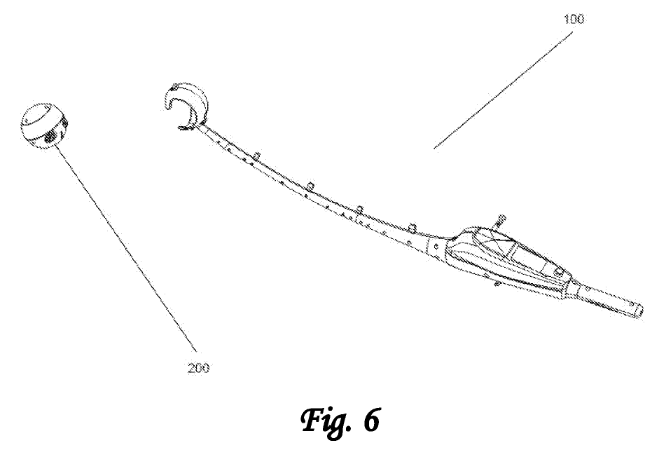

FIG. 3 and FIG. 4 show a physical embodiment of the handheld piece with a left side perspective view (FIG. 3) and a right side perspective view (FIG. 4). As shown in these drawings, the handheld piece may retain the form of a fishing rod while incorporating the electronic components in its structure. FIG. 5 shows the handheld piece in combination with the spherical aquatic drone before the aquatic drone is launched. Here the aquatic drone is held in a cup-like holding chamber at the top of the handheld piece. FIG. 6 shows the handheld piece in combination with the spherical aquatic drone after the aquatic drone is manually propelled from the cup-like structure.

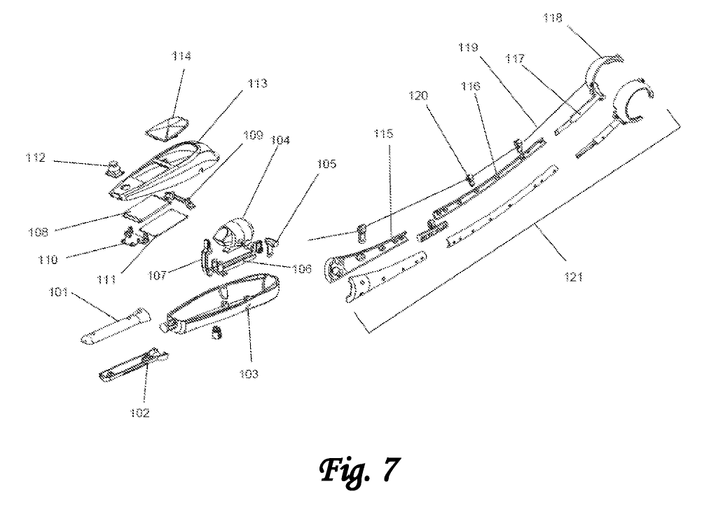

Referring to FIG. 7, this is an exploded view of the handheld piece to show its major futures and the internal and external parts.

The handheld piece 100 has a handheld piece handle upper section 101 and handheld piece handle lower section 102 that may be any material or form that lends a more comfortable ability to hold the device. There are a lower section of case 103 and upper section of case 113 houses the electronics (reel 104, reel crank 105, lateral support for reel release trigger 106, reel release trigger 107, LCD touch display 108, mounting frame LCD display top 109, mounting frame LCD display bottom 110, mounting frame LCD display back 111, joy stick 112, decorative front panel 114 and reel 117).

The upper part of the handheld piece 121 consists of split section of handheld piece 115, middle split section of handheld piece 116, split section for launching pod 117 and the holding chamber 118 to house the aquatic drone. The handheld piece fishing line 119 extends threaded through a series of stabilization rings 120 and then enters through the back of the holding chamber of the aquatic drone.

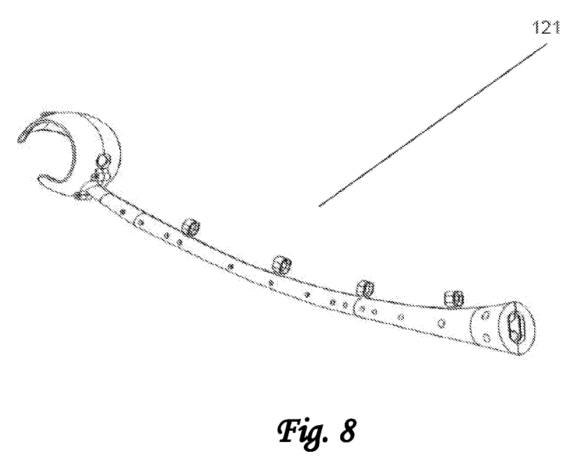

Referring to FIG. 8, this is a left perspective view of the upper part of the handheld piece without the aquatic drone.

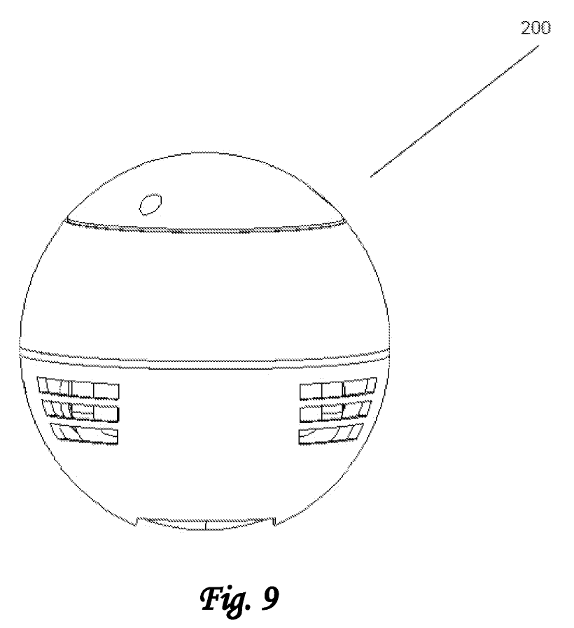

Referring to FIG. 9, this is a front view of the embodiment of the aquatic drone in FIG. 8. In this embodiment, the aquatic drone is near-spherical in shape. In alternative embodiments, it may take the shapes of spheroids or ovoidal shapes.

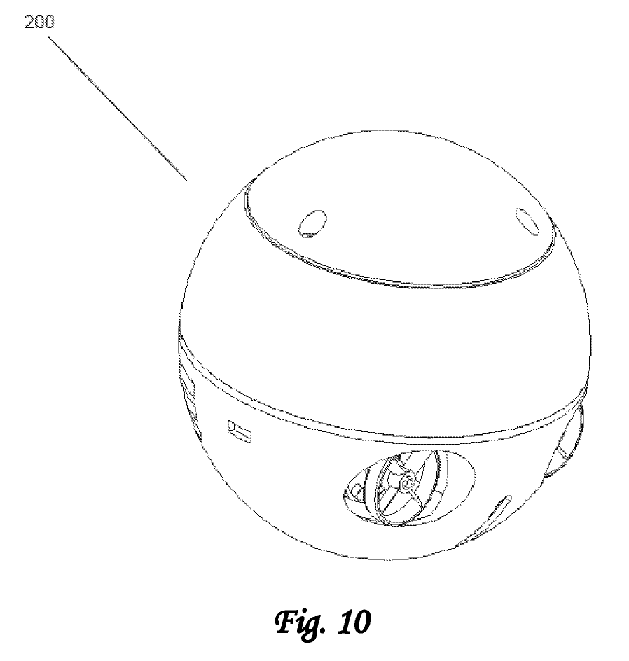

Referring to FIG. 10, this is a perspective view of the aquatic drone.

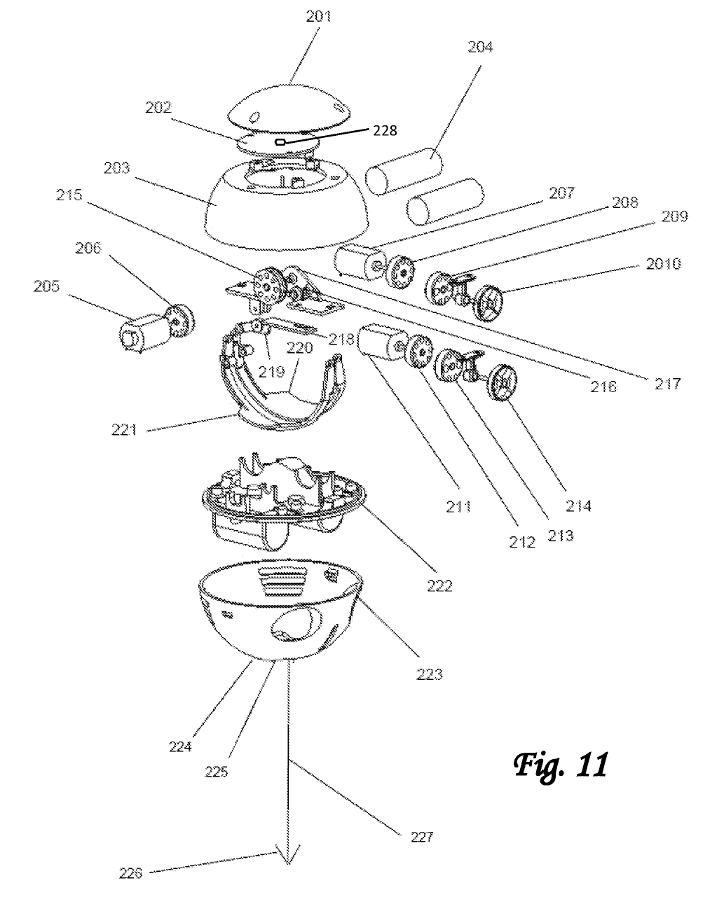

Referring to FIG. 11, this is an exploded view of the aquatic drone to show all the internal and external parts, including the drone external shell top half 203, chassis for the drone 222, drone external shell bottom half 223 of the drone 200, translucent dome 201, printed circuit board 202, battery 204 as a power source to run the drone 200 and all the electronics inside it, drone motor for line release and uptake 205 and magnetic coupling and rotating of the drone motor for line release and uptake 206 connected, first drone propulsion motor 207 and magnetic coupling and rotating of the first drone propulsion motor 208 connected, magnetic coupler of propeller to first drone propulsion motor 209 and propeller of the first drone propulsion motor 210 connected, second drone propulsion motor 211 and connected magnetic coupler and rotating of the second drone propulsion motor 212, and a connected magnetic coupler of propeller to the second drone propulsion motor 213 with the propeller of the second drone propulsion motor 214, a spindle for line release 215, pressure roller for securing line to spindle 216, polymer support and mounting frame for spindle 217, drone bay control level 218, the inside part of the drone bay control level 219, right bay access door to hock and bay 220, left bay access door to hock and bait 221. In addition, there is a light-emitting diode (LED) 228 on the top part of the drone and visible through the translucent dome 201.

The drone is composed of drone external shell top half 203 that has hard outer surface and is filled with a material that allows the drone external shell top half 203 to float. This material may be a spray liquid foam that when dries is hardened to a porous structure that will float. The drone external shell top half 203 also has on its translucent dome 201 a strobe light that is used to help locate the bot and may also be used as an alert mechanism.

When a desired event occurs such as a fish being caught. The lower portion of the robotic vessel houses two side-by-side motors, First drone propulsion motor 207 that have propeller of the first drone propulsion motor 210 connected to allow the drone to navigate in a liquid environment, and the second drone propulsion motor 211 that have propeller of the second drone propulsion motor 214 connected to allow the drone to navigate in a liquid environment.

The drone external shell top half 203, chassis for the drone 222 and drone external shell bottom half 223 contains the supporting electronics and power means to drive first drone propulsion motor 207 and the second drone propulsion motor 211 and illuminate the strobe light, as well as a secondary light on the bottom of the drone 224 that faces into the liquid.

The hatch 225 can be opened by the control board and LCD touch display 300 and allow hook 226 to be suspended from a segment of the drone fishing line 227 where it is tethered to the drone 200. The drone fishing line 227 may be manually adjusted in size to allow the hook 226 assembly the optimal length of suspension for the particular fishing environment.

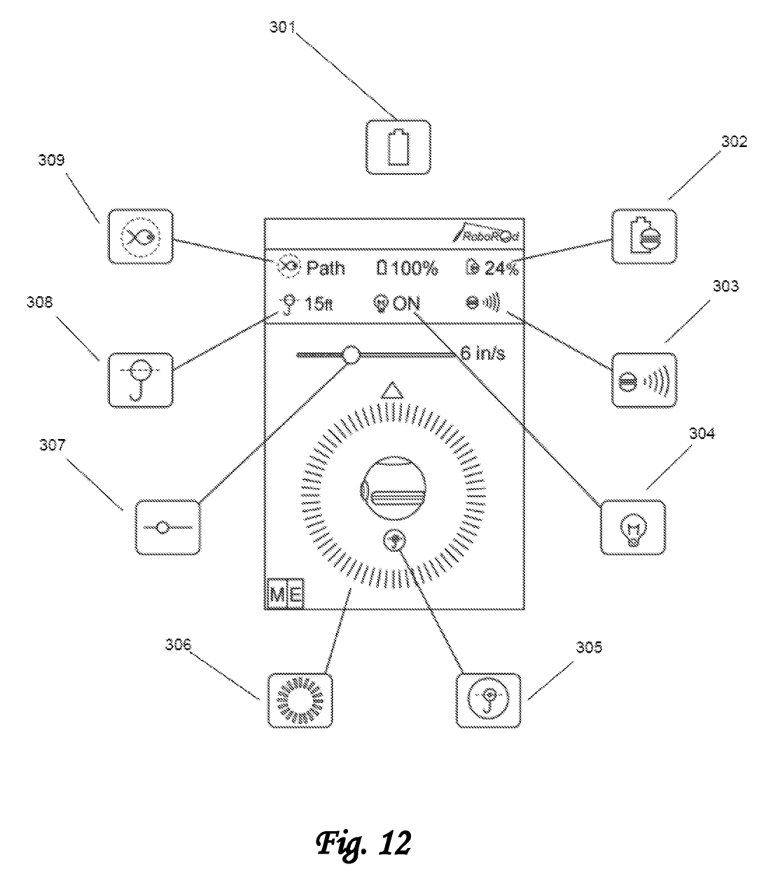

Referring to FIG. 12, this is the control board and LCD touch display, this is is the control board and LCD touch display 300 installed on the handheld piece 100 and equipped with means to wirelessly transmit data and receive data from the handheld piece 100 to the drone 200 in addition to having the means to wirelessly transmit and receive data from an outside device or network with wireless transmission means such as a smartphone.

The handheld piece is activated by an on/off switch located on the case which powers up the control board and LCD touch display. The default position of the drone is attached to the launch pod for the drone. When the power is on the LCD touch display 108 is active and all the controls are accessible. The graphic below describes each of the controls for the handheld piece 100.

Beginning from the top going clockwise, Main battery indicator 301 shows level of battery for the battery inside the case of the handheld piece. Battery indicator for the drone 302, display level of battery remaining in drone. Main controller transmitter signal to drone 303, indicator for RF signal between main board and drone or SSI signal strength indicator. Illumination on/off switch for drone beacon 304. Control to release hook and bait from the bottom bay of the drone 305.

Rainbow directional controller for the drone 306 which allows the white index triangle to be placed anywhere on the circumference of the indicator to control the direction and heading of the drone. Slider indicator for controlling the power of the motors and the speed of movement of the drone 307. Sinker line gauge 308 presets or sets in real time the amount of line extending from the spindle (spool) of the drone to the end of the hook. The fish icon 309 is to preset or set in real time the path(s) that the drone follows in a repeating format.

In general, to use the present invention, after setting the display the angler launches the drone 200 by lightly flinging the drone 200 onto the surface of the water a few feet from where they are standing. In order to accomplish this the person must coordinate the depressing of the trigger underneath the case that is aligned with the reel button on the back of the internal reel 104 which allows for the release of the drone fishing line 227. This is the standard operation for a spincast reel. The drone 200 is then released on the surface of the water and the operator can begin to steer and adjust the speed of the drone using the touch display or the joystick depending upon their preference. The joy stick 112 also has both speed and directional control. Upon reach a preferred location the bait and hook activation control is pressed and the two bay doors begin to retract in opposite directions creating an open space for the hook and bait to be released. The bait then auto spools to the length that has been preset. One of the unique features of the present invention is to manually or automatically set the length of the sinker line in addition to having the capability to have the line automatically retract and then descend again repeatedly. When the fish bites the hook 226 the angler begins to reel line using the conventional reel. Once the fish has been brought back to the angler the fish may be released from the line in typical fashion and then the new bait is replaced on the line, the drone doors are manually closed and the cycle may be repeated.

When the main unit is charged it also charges the drone through a conductive means that is between the drone body and the launching pod which is connected by conductive material to the main control unit.

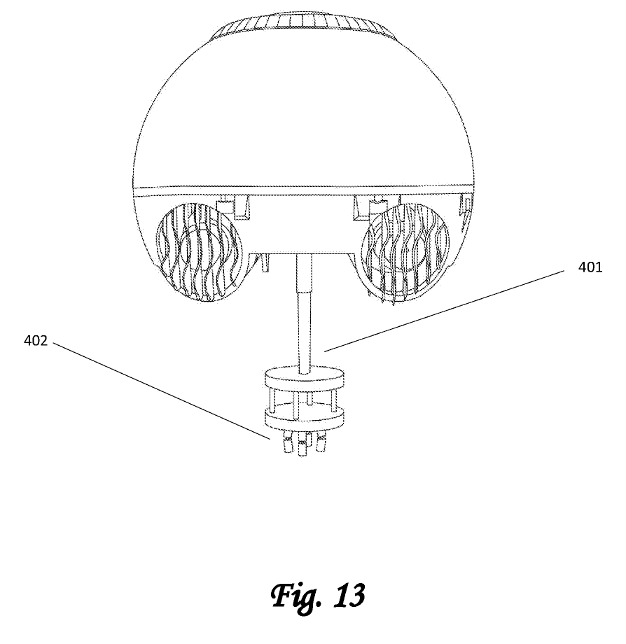

FIG. 13 shows an alternative embodiment of the aquatic drone for non-fishing aquatic applications. By replacing the fishing hook with a robotic arm (401) and grasping mechanism (402), the device may be used to fetch or place inanimate bodies or living organisms under water. Additionally, by incorporating on the grasping element a chemical sensor, the operator will be able to detect biological, organic, or inorganic compounds based upon the method used to detect the analyte.

1-5. (canceled)

6. A fishing apparatus comprising:
(a) a hand piece, comprising
a first power source, herein termed as the main power source,
a first communication unit, herein termed as the main communication unit, to send and receive wireless signals,
a first control unit, here in termed as the main control unit, for controlling and coordinating operation of the fishing apparatus,
one or more input devices to input user commands for controlling the operation of fishing apparatus, and
an output device to display the status of the fishing apparatus
(b) an aquatic drone, comprising
means for maintaining a portion of its body above water when the said aquatic drone is placed into a body of water,
a second power source, herein termed as the drone power source,
a second communication unit, herein termed as the drone communication unit, for sending and receiving wireless signals,
a second control unit, herein termed as the drone control unit, for controlling and coordinating operations of the said aquatic drone, and
means for moving and steering in water in any lateral directions;
(c) a first section of fishing line, connecting to both the said hand piece and the said aquatic drone; and
(d) a fishing hook;
wherein the said hand piece further comprising means for reeling in and out the said section of fishing line, and herein the said aquatic drone further comprising means for holding and deploying the said fishing hook.

7. The fishing apparatus according to claim 6, further comprising a second section of fishing line, wherein the said second section of fishing line is connected to the said fishing hook.

8. The fishing apparatus according to claim 7, wherein the said aquatic drone's means for holding and selectively releasing the fishing hook into water comprises:
a compartment located in the lower half of the aquatic drone, wherein the said second section of fishing line and the said fishing hook is stored, herein one end of the second section of fishing line is fastened to the aquatic drone, and the other end of the second section of fishing line is fastened to the fishing hook, and
a compartment hatch that can be opened and closed and is controlled by the drone control unit, herein when the hatch is open, the second section of the fishing line and the said fishing hook can be lowered into water.

9. The fishing apparatus according to claim 6, wherein the aquatic drone has means to be detached from the said first section of fishing line.

10. The fishing apparatus according to claim 6, wherein the aquatic drone has an outer shape selected from a spheroidal shape, a near-spheroidal shape, an ovoidal shape, and a near-ovoidal shape.

11. The fishing apparatus according to claim 6, wherein the aquatic drone has an outer shape of a spherical shape or a near-spherical shape.

12. The fishing apparatus according to claim 6, wherein the said hand piece further comprises means for propelling the said aquatic drone forward and launching it to a distance from the hand piece.

13. The fishing apparatus according to claim 12, wherein the said hand piece's means for propelling the said aquatic drone forward to a distance comprises a cup structure located at the top portion of the hand piece, herein the shape and the size of the cup structure matches that of the said aquatic drone, such that the said aquatic drone can be partially fit inside the said cup structure and can be propelled forward to a distance when a casting motion is applied to the said hand piece.

14. The fishing apparatus according to claim 6, wherein the said aquatic drone's means for maintaining a portion of its body above water comprises a section of the aquatic drone being a hollow structure or a structure comprising a material having lower mass density than water.

15. The fishing apparatus according to claim 14, wherein the said aquatic drone's means for maintaining a portion of its body above water comprises a section of the aquatic drone being a structure comprising a foam made from spray paint.

16. The fishing apparatus according to claim 6, wherein the said aquatic drone's means for moving and steering comprises:
two propellers located inside or on the surface of the aquatic drone,
two motors located in the aquatic drone, each of the two motors connected to one of the said two propellers, wherein the speed and rotational direction of each of the two motors can be varied independently, and
wherein the said drone control unit is electronically connected to the said two motors and controls the rotational direction and speed of each of the said two motors.

17. The fishing apparatus according to claim 6, wherein the hand piece's means for reeling in and out the said first section of fishing line connected to the said aquatic drone comprises
a reel,
a reel crank, and
a reel release trigger.

18. The fishing apparatus according to claim 6, wherein one of the input devices comprises a joystick.

19. The fishing apparatus according to claim 18, wherein the joystick accepts user inputs of the moving direction of the said aquatic drone.

20. The fishing apparatus according to claim 18, wherein the joystick accepting user inputs of moving speed of the said aquatic drone.

21. The fishing apparatus according to claim 6, wherein the output device is a LCD screen mounted on the said hand piece.

22. The fishing apparatus according to claim 21, wherein the LCD screen is an LCD touch screen, herein the LCD touch screen also serves as an input device.

23. The fishing apparatus according to claim 22, wherein information displayed on the LCD screen comprises:
a main battery indicator,
a drone battery indicator,
a main signal indicator,
a control to release the second section of fishing line and the fishing hook from the aquatic drone,
a directional controller for the aquatic drone, and
a slider indicator for controlling the speed of movement of the aquatic drone.

24. The fishing apparatus according to claim 21, wherein the said aquatic drone further comprises an illumination beacon and a digital camera capable of capturing optical images, herein the captured optical images can be transmitted by the said drone communication unit and received by the said main communication unit and be displayed by the said LCD screen.

25. An aquatic apparatus comprising:
(a) a hand piece, comprising:
a first power source, herein termed as the main power source,
a first communication unit, herein termed as the main communication unit, to send and receive wireless signals,
a first control unit, here in termed as the main control unit, for controlling and coordinating operation of the fishing apparatus,
one or more input devices to input user commands for controlling the operation of aquatic apparatus, and
an output device to display the status of the fishing apparatus
(b) an aquatic drone, comprising
means for maintaining a portion of its body above water when the said aquatic drone is placed into a body of water,
a second power source, herein termed as the drone power source,
a second communication unit, herein termed as the drone communication unit, for sending and receiving wireless signals,
a second control unit, herein termed as the drone control unit, for controlling and coordinating operations of the said aquatic drone,
means for moving and steering in water in any lateral directions; and
a sonar sensor or an array of sonar sensors.

26. An aquatic apparatus comprising:
(a) a hand piece, comprising:
a first power source, herein termed as the main power source,
a first communication unit, herein termed as the main communication unit, to send and receive wireless signals from the said aquatic drone,
a first control unit, here in termed as the main control unit, for controlling and coordinating operation of the aquatic apparatus,
one or more input devices to input user commands for controlling the operation of fishing apparatus, and
an output device to display the status of the aquatic apparatus;
(b) an aquatic drone, comprising
means for maintaining a portion of its body above water when the said aquatic drone is placed into a body of water,
a second power source, herein termed as the drone power source,
a second communication unit, herein termed as the drone communication unit, for sending and receiving wireless signals,
a second control unit, herein termed as the drone control unit, for controlling and coordinating operation of the said aquatic drone,
means for moving and steering in water in any lateral directions, and
a robotic arm capable of mechanically grabbing objects; and
(c) a section of flexible line or rope, connected to the said aquatic drone and the said hand piece.

27. The aquatic device according to claim 26, where the said aquatic drone further comprises a illumination beacon and a digital camera capable of capturing optical images.

28. The aquatic device according to claim 26, where the said aquatic drone further comprises a sonar sensor or an array of sonar sensors.
